(19) United States
(12) Patent Application Publication
(10) Pub. No.: US 2008/0111382 A1
(43) Pub. Date: May 15, 2008

(54) SLIDE ASSEMBLY WITH RETAINING MECHANISM

(75) Inventors: Zhi-Ming Duan, Shenzhen (CN); Chin-Hsiu Lin, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/558,473

(22) Filed: Nov. 10, 2006

(51) Int. Cl. E05C 1/08

(52) U.S. Cl. 292/164

(57) ABSTRACT

A retaining mechanism for a slide assembly includes a stop member (60), a retaining member (70), and an unlatching member (80). The stop member is attached to a first slide (30) of the slide assembly. The retaining member is attached to a second slide (90) of the slide assembly. The retaining member includes a movable block (73). The block can prevent the stop member moving from a first side of the block to second side. The unlatching member is movably attached to the second slide. The unlatching member includes an engaging portion (83). When the unlatching member moves along a first direction, the engaging portion urges the block to move along a second direction perpendicular to the first direction for unblocking the stop member.

### BACKGROUND OF THE INVENTION

1. Field of the Invention

The present invention relates to a slide assembly with a retaining mechanism for preventing one slide of the slide assembly being drawn away therefrom without operating.

2. Description of Related Art

A conventional three-section slide for a server (or drawer) includes a first slide, a second slide, and a third slide. A slide-aiding ball member is sandwiched in between any two of the first slide, the second slide, and the third slide so as to smoothen sliding movement. Moreover, the first slide and the second slide have a retaining member and a stop member mounted thereon respectively, for restricting movement. The retaining member is attached to an inner surface of the first slide, and provided with an engaging portion. The stop member is mounted to a front end of the second slide, and provided with a protrusion. To prevent accidental disassembly, when users draw out the first slide from the second slide, the protrusion of the stop member engages with the engaging portion of the retaining member.

Although the engagement of the stop member with the engaging portion can avoid releasing the first slide from the second slide by accident, the portion of the engagement is positioned at the distal end of the second slide, the first slide and the second slide can hurt user's finger by accident when the user directly disengaging the engaging portion from the stop member so as to retract the first slide into the second slide. Therefore, it is inconvenient for users to operate the slide.

What is needed, therefore, is a retaining mechanism for a slide assembly which may be easily and securely operated.

### SUMMARY OF THE INVENTION

A retaining mechanism for a slide assembly includes a stop member, a retaining member, and an unlatching member. The stop member is attached to a first slide of the slide assembly. The retaining member is attached to a second slide of the slide assembly. The retaining member includes a movable block. The block can prevent the stop member moving from a first side of the block to a second side. The unlatching member is movably attached to the second slide. The unlatching member includes an engaging portion. When the unlatching member moves along a first direction, the engaging portion urges the block to move along a second direction perpendicular to the first direction for unblocking the stop member.

Other advantages and novel features will be drawn from the following detailed description of a preferred embodiment with attached drawings, in which:

### BRIEF DESCRIPTION OF THE DRAWINGS

FIG. 1 is a partial, exploded, isometric view of a retaining mechanism of a slide assembly of a preferred embodiment of the present invention, the mechanism including an unlatching pole, a retaining member, and a stop member;

FIG. 2 is similar to FIG. 1, but shown from another aspect;

FIG. 3 is an isometric, exploded view of the retaining member;

FIG. 4 is similar to FIG. 3, but shown from another aspect;

FIG. 5 is an assembled, isometric view of an intermediate slide from an inner side;

FIG. 6 is a view of an alignment of an inner slide from an inner side;

FIG. 7 is an isometric view of the retaining member and the stop member;

FIG. 8 is a view of an alignment of the retaining member, the stop member, and the unlatching pole, the stop member is retained in the retaining member; and

FIG. 9 is similar to FIG. 8, but the retaining member is disengaged from the retaining member.

FIG. 10 is an assembled, isometric view of the inner slide and part of the intermediate slide.

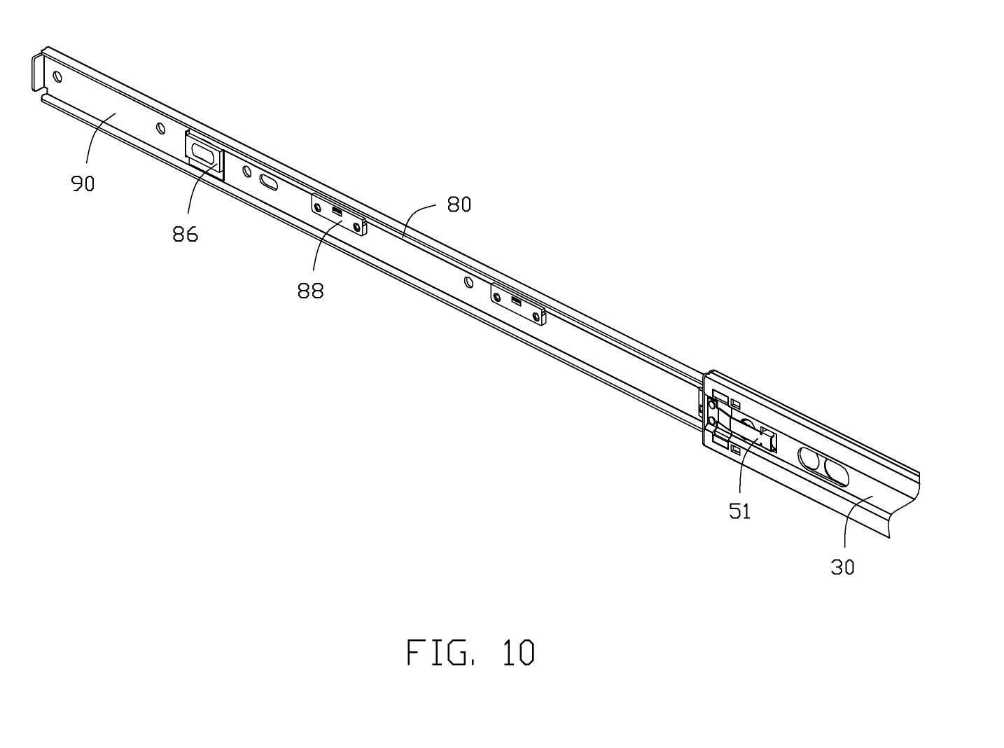

### DETAILED DESCRIPTION OF THE INVENTION

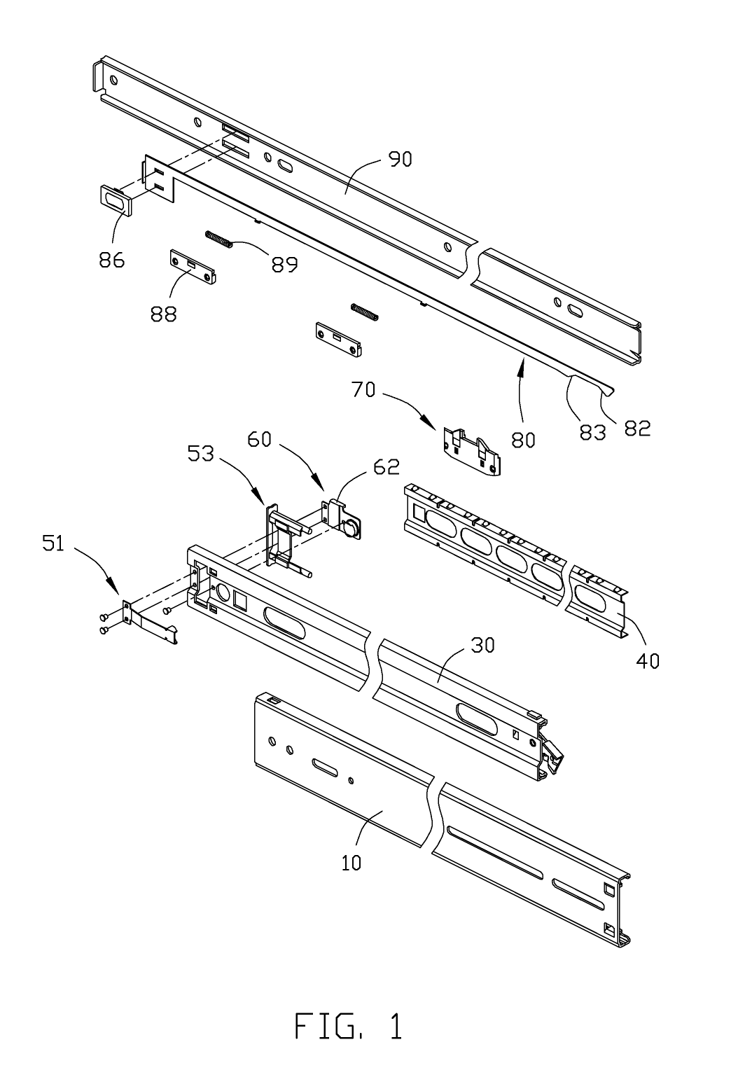

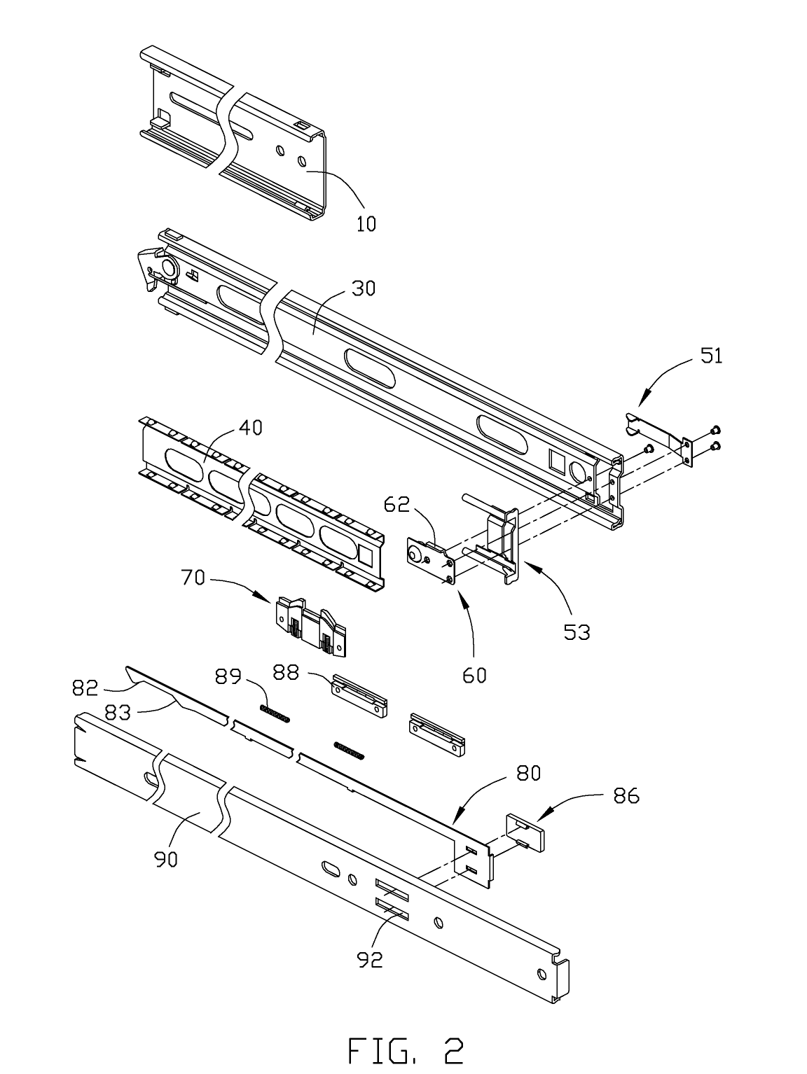

Referring to FIG. 1 and FIG. 2, a retaining mechanism of the preferred embodiment of the present invention is used in a slide assembly. The slide assembly includes an outer slide 10, an intermediate slide 30, and an inner slide 90. A slide-aiding member 40 is sandwiched between the intermediate slide 30 and the inner slide 90 so as to smoothen sliding movement of the inner slide 90 relative to the intermediate slide 30. The outer slide 10, the intermediate slide 30, and the inner slide 90 have mounting flanges thereon for slidingly engaging with each other.

A deformable clip 51, and a base 53 are respectively mounted on outer and inner sides of a back end of the intermediate slide 30 for preventing the slide-aiding member 40 from being withdrawn from the intermediate slide 30.

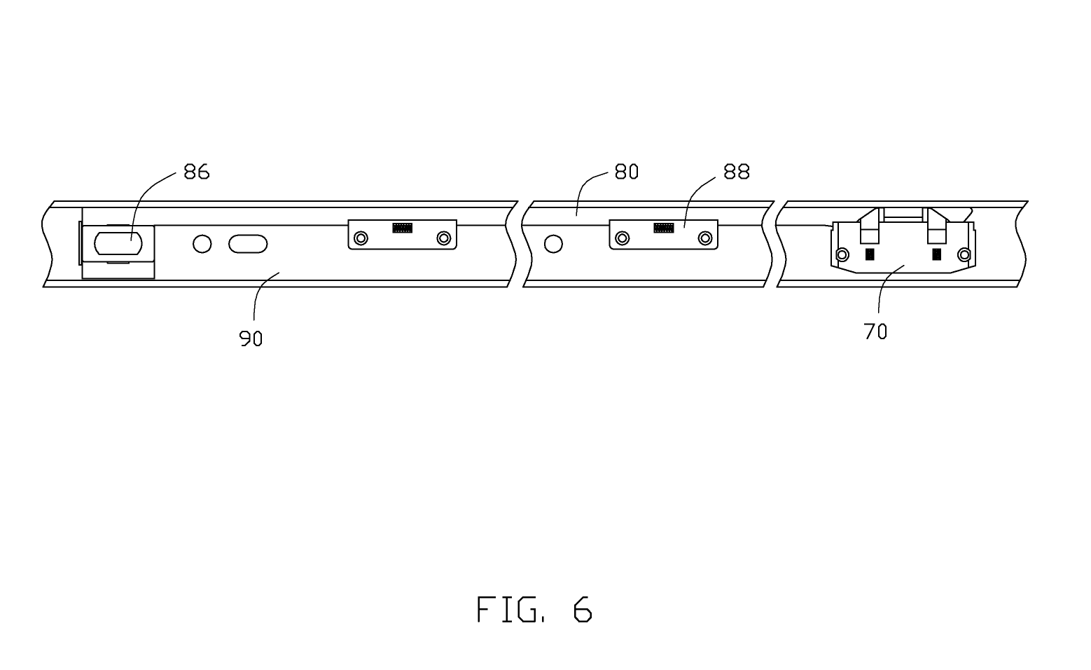

The retaining mechanism includes a stop member 60, which is mounted to the back end of the intermediate slide 30 from inside, a retaining member 70 and an unlatching pole 80. The retaining member 70 is mounted to a front end portion of an inside of the inner slide 90. The unlatching pole 80 is slidably attached to the inner slide 90 along an extending direction of the inner slide 90. Two holding members 88 are mounted to an inside of the inner slide 90 for holding the unlatching pole 80 in the inner slide 90. A spring 89 is set between the unlatching pole 80 and each holding member 88 for pulling or pushing the unlatching pole 80 moving back to an original position (see FIG. 6). The stop member 60 has a stop portion 62 bending out towards the retaining member 70. The unlatching pole 80 has an engaging portion on a front end thereof for engaging with the retaining member 70. The engaging portion has a cutout; a slanted front engaging edge 82 and a slanted back engaging edge 83 are respectively formed in the cutout. An operating grip 86 with a pair of hooks is mounted to an opposite back end of the unlatching pole 80 where a pair of slots is defined.

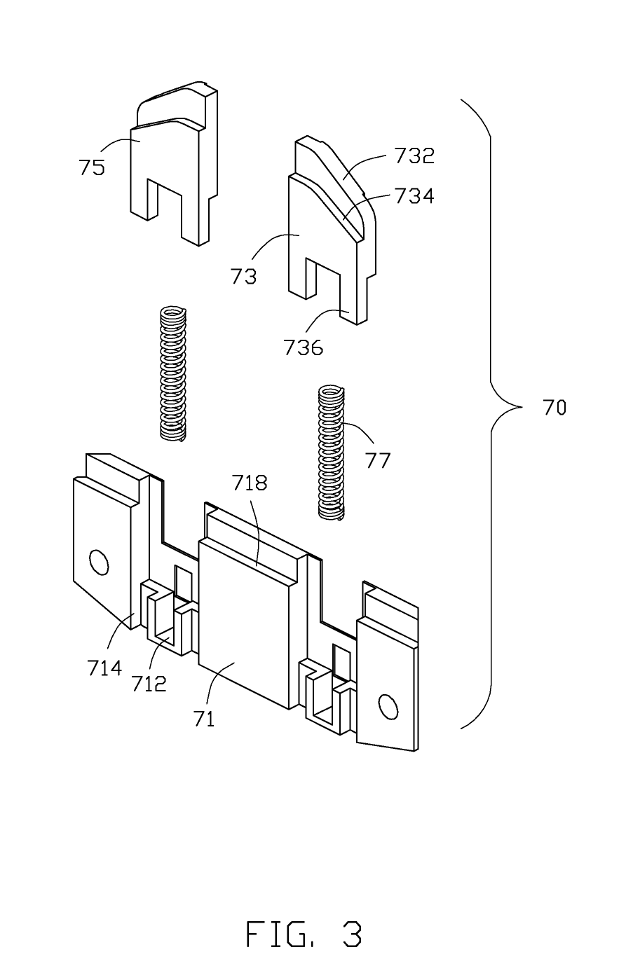

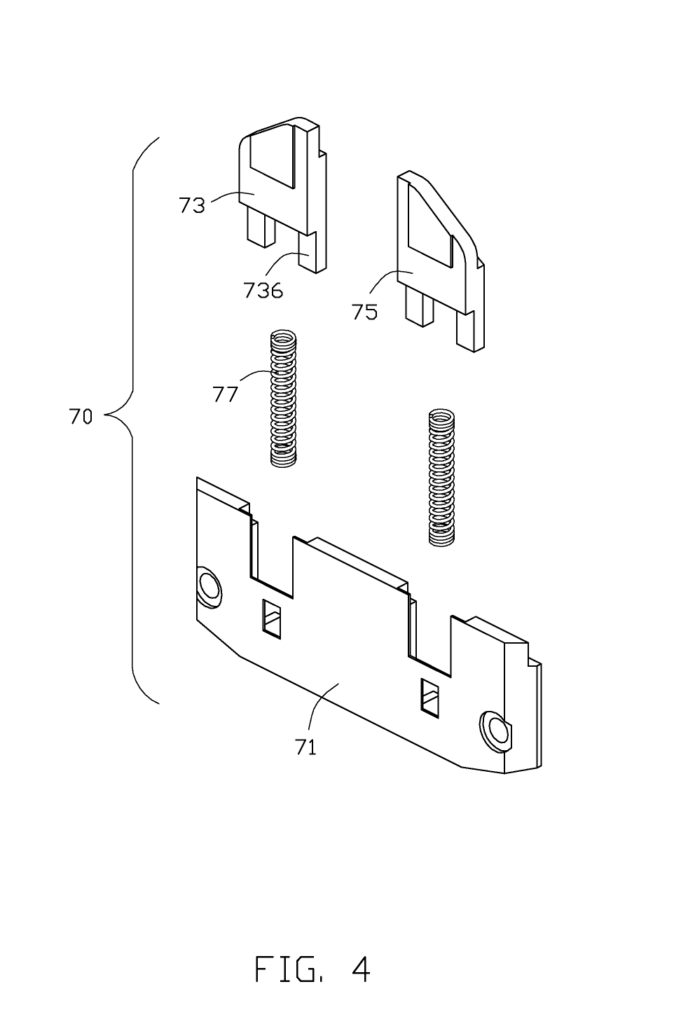

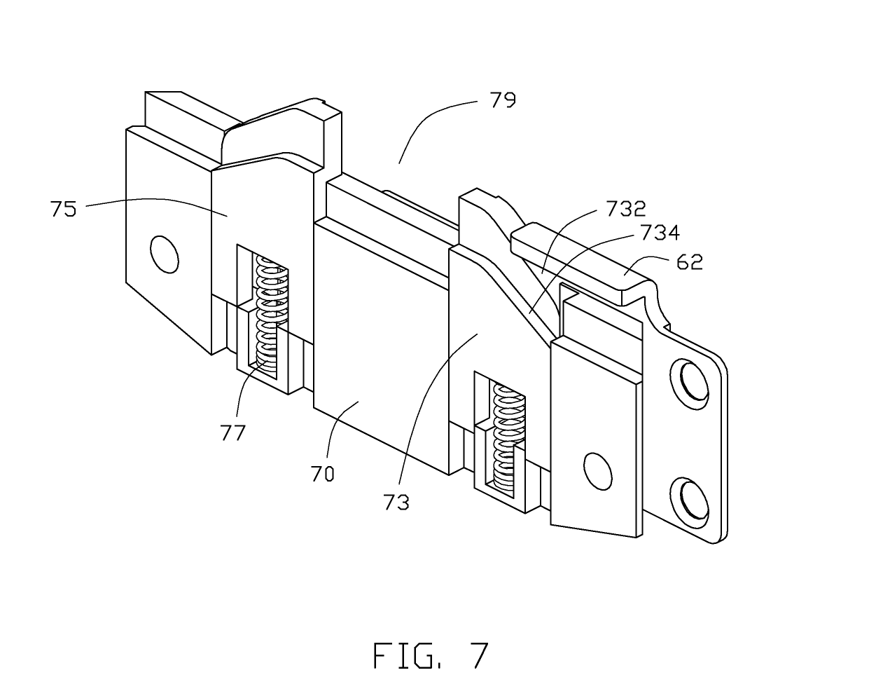

Referring also to FIG. 3 and FIG. 4, the retaining member 70 includes a seat 71, a pair of movable blocks 73, and 75, and a pair of springs 77. The seat 71 defines a pair of slideways for receiving the movable blocks 73, 75. Each slideway has a U-shaped bottom portion 712 for positioning the corresponding spring 77. A pair of slide channels 714 is defined at opposite sides of each bottom portion 712. A guiding way 718 is defined on a top portion of the seat 71 along a horizontal direction. The two movable blocks 73 and 75 are of a mirror image configuration. The movable blocks 73 and 75 each have two feet 736 corresponding to the slide channels 714 of the seat 71. The movable blocks 73 and 75 each have a first inclined portion 732 and a second inclined portion 734 on top thereof. As can be seen in FIG. 3 the first inclined portions 732 are located above and generally parallel to the corresponding second inclined portions 734. The second inclined portion 734 of the block 73 and the second inclined portion of the block 75 are configured for matching with the inclined surfaces 83, 82 of the unlatching pole 80. The first inclined portion 732 of the block 73 and the first inclined portion of the block 75 are configured for providing space to allow the stop portion 62 sliding over the blocks 73, 75 without interference with the unlatching pole 80. A top edge of the seat 71, and the movable blocks 73 and 75 cooperatively form a retaining space 79 (shown in FIG. 7).

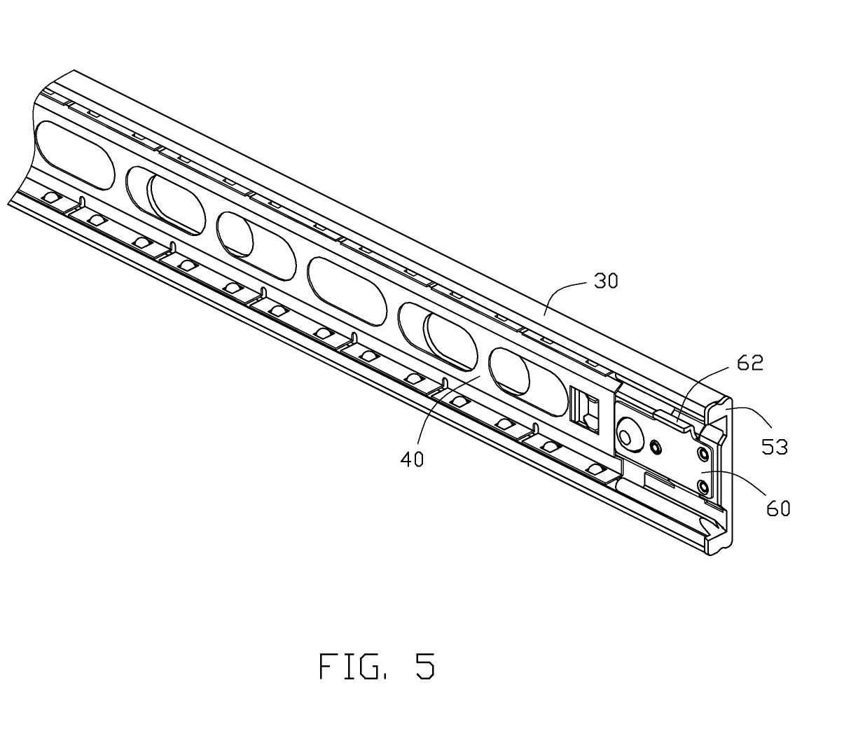

Referring also to FIG. 5 and FIG. 6, the stop member 60 is riveted to the intermediate slide 30. The unlatching pole 80 is movably attached in the inner slide 90 via the hooks of the operating grip 86 slidably engaging with edges of elongated slots 92 of the inner slide 90. The engaging portion of the unlatching pole 80 abuts the top portion of the moving blocks 73, and 75 of the retaining member 70.

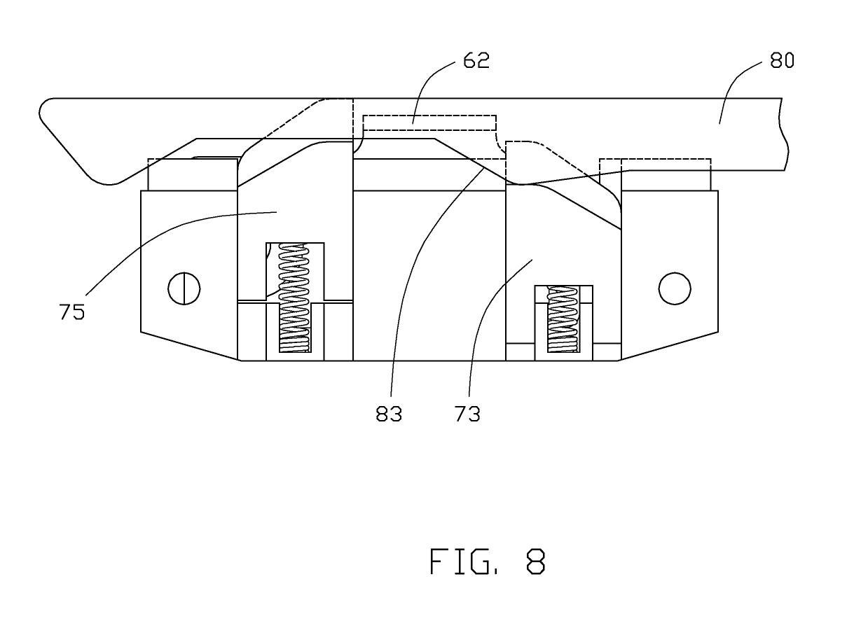

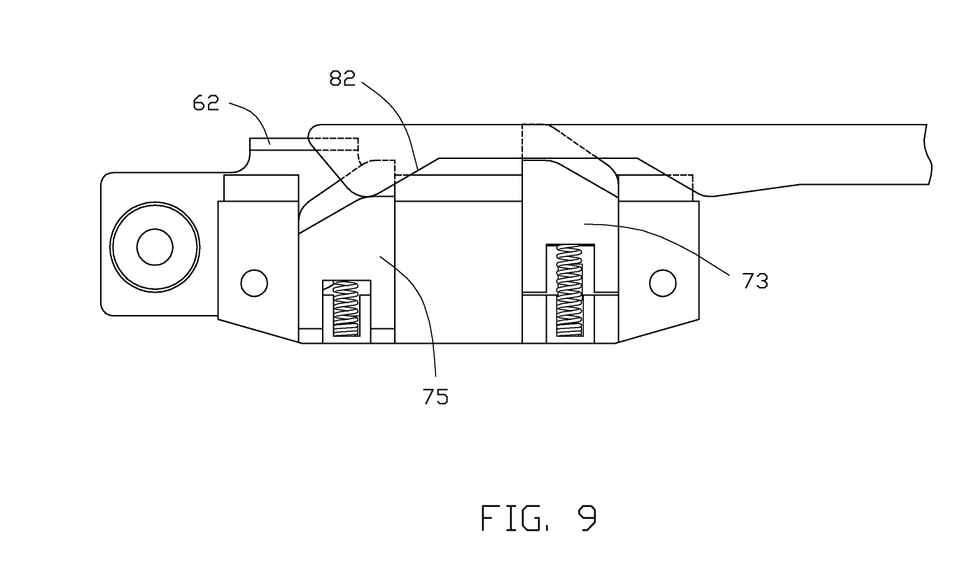

Referring also to FIG. 7 to FIG. 9, when extending the inner slide 90 from the slide assembly, the inner slide 90 slides backward relative to the intermediate slide 30. The retaining member 70 and the unlatching member 80 moves backward relative to the intermediate slide 30. When the stop portion 62 of the stop member 60 abuts against the first inclined portion 732 of the movable block 73, the movable block 73 is urged to move down allowing the stop portion 62 to slide into the retaining space 79. When the stop portion 62 slides into the retaining space 79, the moving block 73 resiliently moves back to the original position. The stop portion 62 is blocked by the moving blocks 75, 73 to prevent the inner slide 90 from further extending and retracting into the intermediate slide 30. The inner slide 90 is thus retained in the intermediate slide 30. An operator can pull back or push forward the unlatching pole 80 so that the slanted front engaging edge 82 or the slanted back engaging edge 83 urges the second inclined portion 754 or 734 of the moving block 75 or 73 to press the corresponding moving block 75 or 73 to slide down. Subsequently, the stop portion 62 of the stop member 60 can be released from the retaining space 79 to a front or back side to let the inner slide 90 separate from the intermediate slide 30 or retract into slide assembly.

It is to be understood, however, that even though numerous characteristics and advantages have been set forth in the foregoing description of a preferred embodiment, together with details of the structure and function of the preferred embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A retaining mechanism for a slide assembly, comprising:
a stop member attached to a first slide of the slide assembly;
a retaining member attached to a second slide of the slide assembly, the retaining member comprising a movable block, wherein the block can prevent the stop member moving from a first side of the block to a second side of the block; and
an unlatching member movably attached to the second slide, the unlatching member comprising an engaging portion, wherein when the unlatching member moves along a first direction, the engaging portion urges the block to move along a second direction perpendicular to the first direction for unblocking the stop member.

2. The retaining mechanism as described in claim 1, wherein the block has a first inclined portion on one side thereof corresponding to the stop member, so that the stop member can slide over the block from the second side of the block to the first side along the inclined portion.

3. The retaining mechanism as described in claim 1, wherein the engaging portion has a cutout, and a slanted engaging edge is formed along the cutout to urge the block.

4. The retaining mechanism as described in claim 1, wherein the retaining member further comprises another block, and a seat, the two blocks structured as mirror images of each other, and the two blocks are slidably attached to the seat in the second direction.

5. The retaining mechanism as described in claim 4, wherein a top edge of the seat and the two blocks cooperatively form a retaining space for holding the stop member.

6. The retaining mechanism as described in claim 5, wherein the engaging portion has two slanted engaging edges, each for urging the corresponding block, so the stop member can be released from the retaining space.

7. The retaining mechanism as described in claim 1, wherein a stop portion is formed on the stop member for engaging with the retaining member.

8. The retaining mechanism as described in claim 1, wherein the unlatching member is a pole, and a spring is positioned between the second slide and the unlatching member.

9. A slide assembly comprising:
a first slide, comprising a stop member on one end; and
a second slide slidably attached to the first slide, the second slide having a retaining member, and an unlatching member movably attached therein, a pair of blocks movably attached to the retaining member, the unlatching member comprising an engaging portion, wherein when the second slide slides with respect to the first slide, the stop member can be retained between the two blocks, and the engaging portion can urge one of the two the blocks to release the stop member via moving the unlatching member relative to the second slide.

10. The slide assembly as described in claim 9, wherein each block has a first inclined portion on one side thereof corresponding to the stop member so that the stop member can urge one of the blocks at one time to move between the two blocks.

11. The slide assembly as described in claim 10, wherein each block further comprises a second inclined portion for abutting against the engaging portion.

12. The slide assembly as described in claim 9, wherein the retaining member further comprising a seat, the two blocks are mirror images of each other in structure, and the two blocks are slidably attached to the seat.

13. The slide assembly as described in claim 9, wherein the blocks can slide along a direction perpendicular to the moving direction of the unlatching member.

14. The slide assembly as described in claim 13, wherein the engaging portion has two slanted engaging edges each for urging the corresponding block.

15. The slide assembly as described in claim 9, wherein the unlatching member is a pole, and a spring is positioned between the second slide and the unlatching member.

16. A slide assembly comprising:
a first slide with a stop member arranged at one end thereof;
a second slide slidably attached to the first slide;
a retaining member secured to the second slide and having a pair of spaced blocks movable relative to the second slide, and
an unlatching member movably attached to the second slide, the unlatching member comprising an engaging portion,
wherein the second slide is extendable with respect to the first slide in a first direction to allow the stop member sliding over one of the blocks to be blocked between the blocks to thereby position the second slide to the first slide, and the unlatching member is slidable with respect to the second slide in a second direction opposing to the first direction to cause the engaging portion to urge the one of the two blocks to move in a third direction perpendicular to the first and second directions to release the stop member whereby the second slide can be retracted in the first slide in the second direction.

17. The slide assembly as claimed in claim 16, wherein the unlatching member is slidable with respect to the second slide in the first direction to cause the engaging portion to urge the other one of the blocks to move in the third direction to release the stop member whereby the second slide can be withdrawn from the first slide.

18. The slide assembly as claimed in claim 17, wherein a resilient member is set between the unlatching member and the second slide for driving the unlatching member back to its original position after the unlatching member being slid away from its original position.

19. The slide assembly as claimed in claim 17, wherein a resilient member is set between each of the blocks and the retaining member for driving the blocks back to its original position after the blocks being moved away from its original position.

20. The slide assembly as claimed in claim 17, wherein the engaging portion comprises a pair of spaced slanted surfaces symmetry to each other about a middle line therebetween, and each of the blocks forms a slanted surface corresponding to one of the slanted surfaces of the engaging portion.
